(19) United States
(12) Patent Application Publication
(10) Pub. No.: US 2006/0042530 A1
(43) Pub. Date: Mar. 2, 2006

(54) Product for and method of aerial seeding using agglomerated minerals

(76) Inventors: Frederick M. Bodycomb, Springfield, CO (US); Charles S. Smith, Hudson, OH (US)

Correspondence Address: Timothy B. Smith, Suite 1300, 185 South State Street, Salt Lake City, UT, 84111, US

(21) Appl. No.: 11/003,800

(22) Filed: Dec. 2, 2004

Related U.S. Application Data
(63) Continuation-in-part of application No. 10/930,068, filed on Aug. 30, 2004.

(51) Int. Cl. A01C 1/04; A01C 1/00

(52) U.S. Cl. 111/200

(57) ABSTRACT

This invention pertains to the restoration of fire-burned or otherwise denuded areas by use of airborne delivered seed and mineral containing pellets. Seed is agglomerated along with minerals and other desirable components into a pellet that is easily and inexpensively produced that is dropped from any number of airborne platforms onto the area in need of re-vegetation. The product and method of the present invention provide safe, inexpensive and efficient means for restoring denuded areas.

### RELATED APPLICATION

This application is a continuation-in-part of Ser. No. 10/930,068 filed Aug. 30, 2004, now pending, by the inventors hereof, under the title “Agglomerated Perlite,” where the contents thereof are incorporated herein in their entirety.

### FIELD OF THE INVENTION

The present invention relates to the field of seeding areas of land, more particularly to a method of dropping seed/mineral pellets via an airborne delivery platform, such as an airplane, helicopter, or other related vehicle.

### BACKGROUND OF THE INVENTION

The present invention relates to a new product and method for delivering seeds to burned, eroded, overgrazed, mining damaged or otherwise denuded areas, such as those that may have been subject to a fire, in order to restore the fire-burned and otherwise denuded and damaged areas. The co-pending application, noted above and of which we are the co-inventors, the contents of which are incorporated herein in their entirety, teaches an agglomerated expanded perlite product capable of acting as a seed carrier.

The destruction caused by forest or grass fires can have an extremely negative impact on the environment. Often, areas are stricken of all vegetation, which can lead to, among other things, severe erosion and landslide conditions. It is desirable to rapidly replace the vegetation destroyed by a forest or grass fire. It can be difficult, however, to access the areas affected by a fire.

Present methods of aerial re-seeding are believed to be limited to the scattering of dry seed or spraying in the form of an aqueous slurry. Such methods are subject to drifting in the wind, resulting in aircraft operating time reduced to near-windless conditions. The seed or slurry may easily be moved by wind or water once it hits the ground. The use of a slurry also requires the use of additional ground personnel to mix and load the slurry into the aircraft. It is extremely difficult to accurately place the seed or slurry often resulting in fertilizers or other chemicals dropped with the seed contaminating streams or other water sources. Another drawback to aerial delivery of dry seeds or a slurry mixture is a requirement that aircraft fly at relatively low altitudes to achieve accurate placement of the seeds. In mountainous regions, where fires frequently strike, the seed delivering aircraft risks running into a mountainside.

Even if an area is accessible and can be re-seeded by hand, such a process can be extremely expensive and time consuming as individuals are required to transplant seeds or seedlings to the desired area. Seedlings especially are very fragile and must be handled carefully. That is not the case for the seed/mineral pellets that are utilized in this invention. The seed/mineral pellets can be handled roughly and do not require the utilization of any special equipment. Spillage may be cleaned up with a broom and shovel.

Previously, it has been attempted to use pelletized seed containing polyacrylamide to reseed fire stricken areas. The use of polyacrylamide, however, can be environmentally dangerous and requires the use of special equipment. The Material Safety Data Sheet for this material indicates that an individual working with pelletized seed containing polyacrylamide is required to wear a respirator, protective goggles, protective gloves and other protective clothing. Polyacrylamide may irritate the eyes, skin and lungs if it comes into contact with a person's body or is inhaled. Polyacrylamide is combustible, and if it does combust, can release hydrogen cyanide gas, among other noxious gases. Indeed, such gases may be released if polyacrylamide simply thermally decomposes. Additionally, polyacrylamide is highly expansive if it becomes wet. If polyacrylamide inside an aircraft were to become wet, it can greatly expand, and it is possible that the aircraft could quickly become unstable. Finally, exposure to polyacrylamide can cause cancer in humans.

Accordingly, there is a need for an efficient, rapid, and inexpensive method for accurately re-seeding fire stricken areas, or areas otherwise denuded from overgrazing, mining, etc., by aircraft. There is also a need to utilize materials that are environmentally friendly and not harmful to those involved in the re-seeding process or to the environment.

### SUMMARY OF THE INVENTION

The present invention provides a solution to existing needs as well as many others. This invention relates to aerial re-seeding of fire burned vegetative areas, although it is understood that it may be used to seed other denuded areas as well. Desired seeds are mixed with a mineral with outstanding water retention characteristics, such as expanded perlite. Other absorptive minerals may be used, as listed below. Additionally, fertilizer, pesticides, insecticides, rodenticides, germination initiators and/or other useful materials may be added to the agglomerated seed/mineral composition to improve the growth and survivability characteristics of the included seeds. The seed/mineral pellets may also include recycled materials, such as newsprint, and materials that are now considered a waste material requiring disposal, such as fines from the expansion of perlite. The seed/mineral pellets are of such a weight and density that they are not easily scattered by wind when dropped from an aircraft and are less likely to be consumed by insects or rodents. The aircraft delivering the pellets can fly at normal speeds when dropping the seed/mineral pellets, and are not required to fly at excessively low altitudes. Because of the water retention characteristics of the mineral, the seeds have a greater chance of germinating in areas with minimal water.

The advantages of re-seeding with an agglomerated seed/mineral mixture include: (1) less prone to drifting in the wind resulting in more accurate placement and allowing aircraft to operate in windier conditions, i.e. more of the time; (2) less likely to be moved by wind or water after placement, unlike dry seed or slurries that can be washed or blown into streams; (3) more even distribution of seed so you do not end up with too much seed in one area and too little seed in another; (4) less ground support required, i.e. no mixing, proportioning, etc. as is required with slurries, resulting in lower manpower requirements, a reduction in equipment and fuel usage, and no need for large water sources (as is required with slurries); (5) no spills on the ground which are difficult to clean up as with liquids (can be cleaned up with shovel and broom); (6) more accurate placement reduces contamination of streams and lakes by fertilizer dropped with the seed/mineral pellet; (7) incorporation of fertilizer with seed in a pellet guarantees that the fertilizer is precisely where the seed lands and is therefore readily available to the seed and reduces runoff of fertilizer into water courses; (8) absorbent/adsorbent materials can provide water to the seed in amounts that would exceed that presented to the seed by natural means if the seed were simply dropped on the ground.

The minerals used in this invention are in themselves, products of nature, and do not require the use of any special equipment or protective clothing nor are they known to pose a hazard to handlers or the environment. The minerals are not combustible. In some instances, the minerals would not cause any ill effects even if they were ingested in small quantities. Finally, since seed/mineral pellets are natural materials, they are environmentally friendly and easily assimilated into the environment into which they are introduced. Other advantages will become evident as the product and method of this invention become established.

Accordingly, one aspect of this invention is to provide an improved method for aerial re-seeding of fire affected and otherwise denuded areas by using agglomerated seed/mineral mixtures.

It is another aspect of the invention to provide seed/mineral pellets to be used in aerial re-seeding that do not require special handling and are not considered hazardous material.

It is another object of the invention to provide seed/mineral pellets that are environmentally friendly and utilize recycled or waste materials.

It is another aspect of the invention to provide seed/mineral pellets to be used in aerial re-seeding which contain materials that help facilitate the germination and growth of the seeds contained in the pellet.

It is another aspect of the invention to provide a relatively inexpensive, rapid and accurate method for re-seeding areas decimated by forest or grass fires that does not require hand planting.

It is another aspect of the invention to provide a method and product for delivering grain or other feed seeds to assist in the survival or restoration of wildlife to a particular area.

It is another aspect of the invention to provide a method for aerial re-seeding that does not require the aircraft operator to fly at slower than normal speeds or abnormally low altitudes.

Another aspect of the invention is to use seed/mineral pellets as a seed delivery system that is relatively resistant to wind dispersal or bird or animal consumption.

These and other features and advantages of the preferred embodiment of the present invention will become apparent from the detailed description of the invention.

### DETAILED DESCRIPTION OF THE INVENTION

The basis of this invention is the use of aerially dropped agglomerated seed/mineral pellets to restore fire-burned or areas denuded from overgrazing, erosion, mining or other similar events. The pellets are formed by known agglomeration methods, including but not limited to a tumbling/agitation method, such as a pelletizing disc or granulating drum; a pressure method, such as briquetting, tableting and/or pressing; an extrusion method; a pelletizing method, such as pelletizing discs; or other agglomeration technology or methods.

The pellets are formed using absorptive/adsorptive materials such as expanded perlite, diatomaceous earth (diatomite), clays, pumice, pumicite or volcanic ash (expanded or not); cellulose or other fibrous materials such as newsprint, cotton, wool, or other fibrous minerals; binders such as liquids, including water, acids, bases, waste liquids, waste liquid/solid mixtures, liquid or solid fertilizers, oils (vegetable, mineral, natural and refined), sugars, starches, adhesives, and polymers; and may contain fertilizers, rodenticides, insecticides, herbicides, and/or germination enhancers or initiators such as butenolides. These materials aid in pelletization or reinforce the resulting forms and improve germination and growth. It may also be advantageous to use biodegradable materials to aid in agglomeration so that after being dropped, the pellets will more quickly disintegrate and disperse the seed into the soil. In order to increase the strength of the seed/mineral pellet, delay germination or reduce particle abrasion, a coating, such as hydroxyethyl cellulose or other water soluble material might be applied to the pellet. Rain subsequent to placement would dissolve the coating, saturate the pellet, and trigger germination.

Agglomerated seed/mineral pellets may be created according to what is best suited for a particular area. For example, seeds from vegetation native to the denuded area would be agglomerated into the mineral of choice along with fertilizers, pesticides, herbicides and rodenticides most appropriate for the particular ecosystem of the denuded area. It may also be desirable to include grain or other similar seeds in the pellets, along with seeds intended for general revegetation. The maturation of grain seeds will aid in wildlife survival or repopulation. The appropriate seed/mineral pellets are then delivered to the aircraft that will be used to disperse the pellets. There is no requirement for ground personnel to perform any mixing or proportioning, reducing costs and pollution associated with manpower, fuel and water. Instead, the seed/mineral pellets go directly from the truck or other delivery vehicle into the aircraft that will drop the pellets.

Many types of aircraft could be used to deliver the seed/mineral pellets, including but not limited to airplanes, helicopters, remotely piloted vehicles, or other types of aircraft. The operator of the aircraft may fly at safer speeds and altitudes over the denuded area, releasing the seed/mineral pellets at the desired location.

The minerals utilized in the seed/mineral pellets provide exceptional aeration and moisture retention qualities that aid in superior plant growth. When a seed is included in the mineral agglomerate, it is automatically placed in ideal growing conditions. When fertilizer and/or germination promoters are also included in the seed/mineral agglomerate, the growing conditions become even better. Additionally, because the seeds are encased in the seed/mineral agglomerate, there is less likelihood that the seeds will be eaten by birds or other animals, again increasing the probability of successful seed germination. The size and weight of the seed/mineral agglomerate also provide for more precise placement of the seeds contained therein and ensure that the seed will not subsequently be as easily scattered by wind or rain.

While the present invention is particularly well-suited for use in restoring denuded areas, it may also be used in the planting of crops, including trees. Additionally, it may be desirable to aerially deliver pellets that contain a mineral and a fertilizer, herbicide, insecticide, rodenticide, germination initiator or enhancer without any seeds. The seed/mineral pellets could also be delivered from land vehicles or by hand.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What is claimed is:

1. A method of aerial re-seeding comprising:
mixing seeds with an absorptive/adsorptive mineral in an agglomeration process creating a seed/mineral pellet;
placing the seed/mineral pellets into an airborne delivery platform;
delivering said seed/mineral pellets to the desired re-seeding area via the airborne delivery platform; and
dropping the seed/mineral pellets out of the airborne delivery platform to the desired re-seeding area.

2. A method of re-seeding denuded areas comprising:
agglomerating seeds and minerals into a seed/mineral pellet;
delivering said seed/mineral pellet to the denuded area; and
placing the seed/mineral pellet at the desired location within the denuded area.

3. A seed/mineral product comprised of an agglomerated mixture of seed and at least one mineral wherein said agglomerated mixture is produced by an agglomeration process.

4. The seed/mineral product of claim 3 wherein said agglomeration process utilizes tumbling/agitation technology.

5. The seed/mineral product of claim 4 wherein tumbling/agitation technology includes the use of a pelletizing disc or granulating drum.

6. The seed/mineral product of claim 3 wherein said agglomeration process utilizes pressure technology.

7. The seed/mineral product of claim 6 wherein said pressure technology includes briquetting, tableting and/or pressing.

8. The seed/mineral product of claim 3 wherein said agglomeration process utilizes an extrusion method.

9. The seed/mineral product of claim 3 wherein said agglomeration process utilizes a pelletizing method.

10. The seed/mineral product of claim 9 wherein said pelletizing method includes the use of pelletizing discs.

11. The seed/mineral product of claim 3 wherein said mineral is at least one of the group of expanded perlite, diatomaceous earth, diatomite, clays, fullers earth, pumice, pumicite, volcanic ash, or expanded volcanic ash, or expanded pumicite.

12. The seed/mineral product of claim 3 wherein said mixture includes recycled or waste materials.

13. The seed/mineral product of claim 3 wherein said mixture includes a binding agent or agents.

14. The seed/mineral product of claim 13 wherein said binding agent includes at least one of the group of water, acids, bases, waste liquids, waste liquid/solid mixtures, liquid fertilizers, oils, sugars, starches, adhesives, polymers, fibers, cellulose in any form, hydroxyethyl cellulose, newsprint, macerated fabrics, cotton, wool, gypsum, lime, polymeric fibers, clay, bentonite, fullers earth, or formaldehyde.

15. The seed/mineral product of claim 3 wherein said mixture contains seed of one or more desired species of vegetation including trees, bushes, forbs, or grasses.

16. The seed/mineral product of claim 3 wherein said mixture contains seeds of vegetation to be planted as crops including wheat, grain sorghum, sunflowers or trees.

17. The seed/mineral product of claim 3 wherein said mixture contains one or more of the group of fertilizer, herbicides, insecticides, germination enhancers or promoters, and rodenticides.

18. The seed/mineral product of claim 17 wherein said fertilizer may be a liquid, dry solid or time-released type.

19. The seed/mineral product of claim 3 wherein said seed/mineral product is coated with a water soluble or other protective material.

20. The seed/mineral product of claim 3 wherein said mixture contains a butenolide or other material suitable to initiate, enhance or promote seed germination.
